(19) United States
(12) Patent Application Publication
(10) Pub. No.: US 2008/0034918 A1
(43) Pub. Date: Feb. 14, 2008

(54) MULTI-MODE VIBRATION DAMPER HAVING A SPOKED HUB

(75) Inventors: Suhale Manzoor, Cement City, MI (US); Bruce Christenson, Canton, MI (US)

Correspondence Address: SNELL & WILMER L.L.P. (Main), 400 EAST VAN BUREN, ONE ARIZONA CENTER, PHOENIX, AZ, 85004-2202, US

(73) Assignee: HILLSDALE AUTOMOTIVE, LLC, Inkster, MI (US)

(21) Appl. No.: 11/838,072

(22) Filed: Aug. 13, 2007

Related U.S. Application Data
(60) Provisional application No. 60/822,102, filed on Aug. 11, 2006.

(51) Int. Cl. F16F 15/10

(52) U.S. Cl. 74/574.4

(57) ABSTRACT

A multi-mode vibration damper includes a hub comprising radially projecting spokes, an inertia mass defining recesses for receiving the hub spokes and a damping member between the spokes and recess sidewalls. The damping member is configured to provide vibration damping via substantially compressive stress in the damping member between the hub and inertia mass. An exemplary vibration damper provides vibration damping in a plurality of damping modes and at a plurality of damping frequencies. Exemplary embodiments of the vibration damper provide reduced parasitic inertia and a rocking mode below the torsional mode of the damper.

### CROSS-REFERENCE TO RELATED APPLICATIONS

This application claims priority to and the benefit of U.S. Provisional Patent Application No. 60/822,102 filed on Aug. 11, 2006 and entitled “TORSIONAL VIBRATION DAMPER HAVING A SPOKED HUB.” This provisional application is incorporated herein in its entirety by reference.

### FIELD OF INVENTION

This invention generally relates to vibration dampers, and more specifically to multi-mode vibration dampers that damp vibration via substantially compressive stress.

### BACKGROUND OF THE INVENTION

Vibration dampers, such as torsional vibration dampers, are commonly associated with drive mechanisms and power transfer systems, such as crankshafts of piston engines, electric motors, transmissions, drive shafts, and the like. A primary purpose of a vibration damper is to reduce the amplitude of vibrations in such systems, because excessive vibration may cause system noise, wear, fatigue, and catastrophic failure. Such systems typically experience vibration from multiple sources, such as, for example, firing of different engine cylinders, crankshaft imbalances, meshing of gears in transmissions, shaft misalignment, and movement of universal joints.

Common vibration dampers include a hub for mounting the damper to a crankshaft and an annular inertia ring driven by the hub through an elastomeric member secured between the hub and inertia ring. Such common vibration dampers damp vibration by inducing shear stress in the elastomeric member. The outer hub rim and corresponding inner rim of the inertia ring are often coextensive and configured to provide surface area for distribution of the shear forces in the elastomer. Such dampers typically are tuned to a particular range of vibration frequencies that are determined as a function of the material properties and geometry of the elastomeric member, inertia ring, and hub. Rotation of the mass of the inertia ring generates active inertia, which in combination with the cyclical stressing of the elastomer serves to resist the axial and torsional vibrational movement of the crankshaft.

One common type of damper is produced by adhering or forming the elastomeric member on either the hub or ring and by then deforming or heating the hub or inertia ring to fit within or over the corresponding hub-elastomer or inertia ring-elastomer subassembly. For example, a hub-elastomer subassembly having the elastomer molded to the peripheral face of the hub is pressed through a converging tube to radially compress the elastomeric member. The inertia ring is radially expanded through heating and is positioned around the end of the converging tube to receive the compressed hub-elastomer subassembly. The combined expansion of the elastomeric member and subsequent thermal restriction of the inertia ring create a sufficient force to secure the inertia ring to the hub. Similarly, the inertia mass may simply be press-fitted onto the hub-elastomer sub-assembly, comprising the elastomeric member. Alternatively, the elastomeric member may be pushed between the inertia mass and hub using a special blade fixture.

Certain inefficiencies of the damper itself may reduce the overall efficiency or lifecycle of the drive system or peripheral systems. One such inefficiency, parasitic vibration, may be caused by misalignment of a damper hub on a drive shaft or by damage or wear to the shaft or damper, such as deterioration of the elastomeric member. Similarly, parasitic vibration may be caused by irregularities, imbalances, or defects caused in the production of the damper or by subsequent deterioration caused by such defects.

Another inefficiency of conventional dampers is parasitic inertia. Parasitic inertia is generated by mass that creates a torsional load on the dampened system but does not significantly contribute to the active inertia of the damper. For example, parasitic inertia may be generated by any mass of the damper that is located radially inward of the inertia mass.

Conventional vibration dampers exhibit a rocking mode that is typically higher in frequency than the torsional mode. Certain advanced automotive applications, however, require a vibration damper with a rocking mode or response that is below the torsional mode (i.e., the frequency of the rocking mode is lower than the frequency of the torsional mode) and these applications may benefit from a damper having rocking mode that is below the torsional mode.

Accordingly, there exists a need for a more efficient vibration damper providing reduced parasitic vibration and reduced parasitic inertia. Further, a need exists for a torsional vibration damper that exhibits a rocking mode below the torsional mode of the damper.

### SUMMARY OF THE INVENTION

While the way that the present invention addresses the disadvantages of the prior art will be discussed in greater detail below, in general, the present invention provides a vibration damper in which a damping member, such as an elastomeric spring damping member, is disposed between spokes projecting from a damper hub and the sidewalls of corresponding recesses in an inertia mass encompassing the damping member and the hub spokes.

According to one exemplary embodiment of the invention, the damper hub comprises, along with the hub spokes, a shaft receiving portion. The shaft receiving portion serves as a durable interface with a shaft, such as a crankshaft. The damper hub and shaft receiving portion may comprise different materials in order, for example, to reduce hub weight and parasitic inertia. The spoked hub portion is configured to be retained within an inertia mass having spoke recesses corresponding to the spokes of the spoked hub. The damping member is configured to be disposed between the sidewalls of the recesses in the inertia mass and the sides of the hub spokes. The spokes may comprise a flange on the outer edge to impede extrusion of the elastomer from the space between the spokes and the inertia mass. The hub is configured to be retained within the inertia mass by the compressive force of the elastomer on the hub and the inertia mass.

In an exemplary method of assembly, damping member may be disposed over the individual spokes. The damping member may surround at least two sides of each hub spoke. An exemplary damper hub may serve as the assembly fixture for the elastomeric member and may be pressed into the recesses in the inertia mass. The damping member is then compressed between the hub spokes and the sidewalls of the recesses in the inertia mass. In other embodiments, the spring damping member may be formed on or bonded to the hub or inertia mass, or may be injected, such as by injection molding, between the hub and the inertia mass.

Accordingly, the present invention provides a spoked hub within a vibration damper in which the elastomeric spring damping member damps vibration substantially through compression stress, rather than through shear stress, between the hub and inertia mass. Exemplary embodiments of the invention maximize the active inertia and minimize the parasitic inertia and may be configured to exhibit a rocking mode that is below the torsional mode of the damper.

### BRIEF DESCRIPTION OF THE DRAWING FIGURES

A more complete understanding of the present invention may be derived by referring to the detailed description and claims when considered in connection with the drawing Figures, wherein like reference numerals refer to similar elements throughout the Figures, and

FIG. 1 illustrates a break-out view of an exemplary vibration damper according to an embodiment of the present invention;

FIG. 2 illustrates a front assembly view of the exemplary vibration damper of FIG. 1;

FIG. 3 illustrates a cross-sectional view of a hub spoke and damping member within a recess in the inertia mass of the exemplary vibration damper of FIG. 2;

FIG. 4 illustrates a longitudinal cross-sectional view of the exemplary vibration damper of FIG. 2;

FIG. 5 illustrates a perspective view of an exemplary vibration damper according to another embodiment of the present invention;

FIG. 6 illustrates an exploded perspective view of a vibration damper according to another embodiment of the present invention;

FIG. 7 illustrates a perspective view of a vibration damper according to a further embodiment of the present invention;

### DETAILED DESCRIPTION OF EXEMPLARY EMBODIMENTS

The following description is of certain exemplary embodiments of the present invention only, and is not intended to limit the scope, applicability or configuration of the invention. Rather, the following description is intended to provide a convenient illustration for implementing various embodiments of the invention. As will become apparent, various changes may be made in the function and/or arrangement of the elements described in these embodiments without limiting or diminishing the scope of the invention as set forth herein. It should be appreciated that the description herein may be adapted to be employed with various embodiments configured to comprise different shapes, components, materials and the like and still fall within the scope of the present invention. Thus, the detailed description herein is presented for purposes of illustration only and not of limitation.

A multi-mode vibration damper according to various embodiments of the present invention comprises an inertia mass having multiple recesses configured to retain circumferentially-spaced, radially-extending flanges or “spokes” formed on the damper hub. Torque and vibration may be transferred from a crankshaft to the damper hub via a shaft receiving portion within the hub. The hub in turn is configured to transfer this torque and at least a portion of the vibration to the inertia mass through a damping member, such as an elastomeric spring damping member, compressed between the faces and sides of the spokes of the hub and the sidewalls of the recesses in the inertia mass.

In various other embodiments, the hub spokes are configured to flare outwardly towards the outer face of the inertia mass to impede the extrusion of the elastomeric spring damping member from the recess. Similarly, the recesses may include inwardly extending lips to further impede the extrusion of the elastomeric member from the recess. These spoke and recess features further serve to place the elastomeric spring damping member in a more uniform state of compressive stress throughout their cross-sections. In certain embodiments, the elastomeric spring damping member may be configured to be separate and/or to comprise multiple elastomer portions, and the damping member portions may be placed individually over each of the hub spokes. In other embodiments, a single, integral elastomeric member may be fitted over the hub spokes before assembly of the inertia mass to the hub. In still other embodiments, the elastomeric member may be formed on or between the hub and inertia mass. For example, the spring damping member may be injection molded between the inertia mass and the damping hub. Further embodiments of the invention provide other means for disposing the damping member between the inertia mass and the damping hub such that the spring damping member is substantially in compression and not in shear when subjected to various damping modes.

Exemplary embodiments of the present invention provide vibration dampers configured to reduce parasitic inertia and vibration by replacing the conventional lateral flange portion of the hub with circumferentially spaced spokes. Exemplary spokes may be comprised of metal, plastic, composite material, combinations thereof, and the like. Other embodiments of the invention comprise spokes made of any material that aids in reducing parasitic inertia and vibration. Still other embodiments of the invention may not be configured to reduce parasitic inertia, but may still be configured to provide vibration damping.

In an exemplary method of manufacturing a torsional vibration damper according to one embodiment of the present invention, a composite hub is formed with an axial bore for receiving a metallic insert and with circumferentially spaced spokes for driving an inertia mass. The metallic insert may be molded, press-fit, or otherwise secured within the bore in the spoked hub portion.

In other exemplary embodiments of the invention, the composite hub and metallic insert are not two separate parts; rather, an exemplary damping hub may be formed with a shaft receiving portion, such that a metallic insert need not be used. Such an exemplary damping hub may be comprised of any material that facilitates the vibration damping characteristics of the vibration damper. The damping hub may comprise a homogenous material, or it may comprise a non-homogeneous material, for example, where the spokes comprise a different material than the shaft receiving portion.

An exemplary inertia mass may be formed with a series of circumferentially-spaced recesses corresponding to the spacing of the spokes of the hub and sized to receive the spokes and the damping member, such that the damping member is disposed around the spokes. An exemplary damping member and/or damping member portions may be configured to at least partially surround the spokes of the hub and are sized to generate compressive forces within the recesses when placed over the spokes and within the recesses. According to further embodiments, the damping member may be configured to damp vibrations substantially via compression stress during various modes of vibration. In certain embodiments, the elastomeric member is positioned at least over each of the circumferentially-facing portions of the hub spokes. In other exemplary embodiments, the elastomeric member covers the radial ends and inward edges of the spokes as well. The elastomeric member may, according to other embodiments, be configured to entirely surround or enclose the spoke. The hub carrying the elastomer member portions is then pressed or otherwise inserted into the recesses in the inertia mass, placing the elastomeric member portions in compression between the hub spokes and recess sidewalls. According to further embodiments of the invention, the damper hub may be disposed within the inertia mass prior to inserting the damping member between the spokes and the spoke recesses in the inertia mass. According to still other embodiments of the invention, the damper hub may be inserted within the inertia mass and then the damping member may be injection molded between the inertia mass and the damper hub.

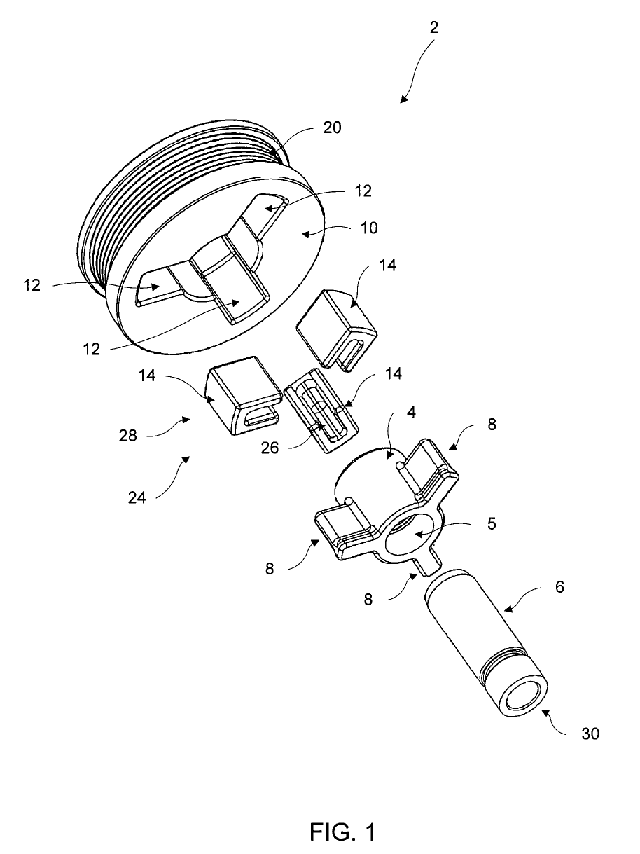

With reference now to FIG. 1, a vibration damper 2 according to one exemplary embodiment of the present invention includes a damper hub 4 configured for attachment to the end of a crankshaft of an internal combustion engine. Hub 4 may include an axial bore 5 for receiving a metallic hub insert 6 for interfacing with the crankshaft via shaft receiving portion 30. Hub 4 may include any other suitable mechanism now known or hereafter developed for connecting damper 2 to a crankshaft.

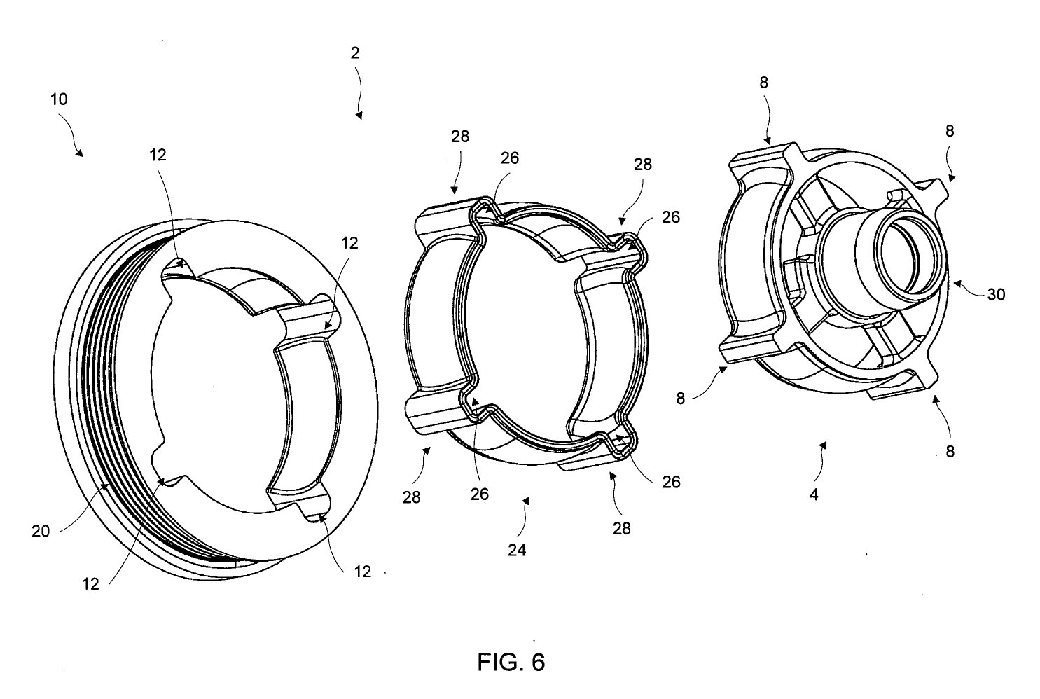

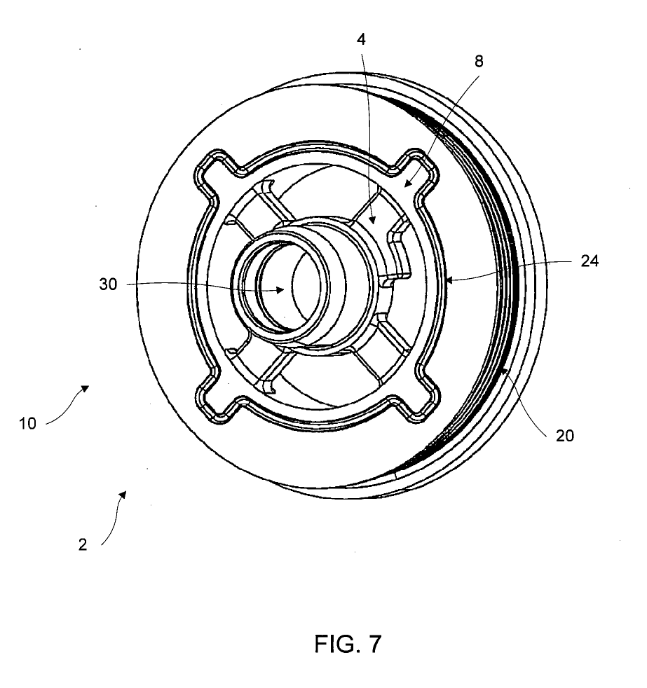

An exemplary damper hub 4 may comprise a plurality of radially-extending, circumferentially-spaced spokes 8. Hub 4 is shown in FIG. 1 with three generally flat rectangular spokes extending substantially perpendicular to axial bore 5. In other embodiments of the invention, hub 4 may comprise more than three spokes. For example, with momentary reference to FIG. 6, an exemplary vibration damper 2 may comprise four spokes 8. Spokes 8 may be configured to be any size or shape suitable to drive an inertia mass and/or provide the desired damping modes depending on a given application. An exemplary hub 4 may be formed from a glass-filled nylon composite material. In other embodiments, hub 4 may be formed entirely of metal or may be formed from any other material or combination of materials suitable to withstand the forces applied to damper 2 and/or to provide the desired damping modes for a particular damper 2. For example, hub 4 and/or insert 6 may be made from grey iron, ductile iron, steel, aluminum, reinforced plastic, and/or other suitable materials.

An exemplary vibration damper 2 may further comprise an inertia mass 10 comprising a plurality of circumferentially-spaced, radially-extending recesses 12 spaced substantially corresponding to spokes 8 on hub 4. Inertia mass 10 may be formed of metal or other material suitable to withstand the rotational vibrations transferred by hub 4 from the crankshaft. Inertia mass 10 may further include a drive pulley track formed on an outer circumferential portion.

According to other exemplary embodiments, damping member 24 is provided for insertion between spokes 8 and recesses 12. Damping member 24 may comprise a single elastomeric portion, for example, as illustrated in FIG. 6. In other embodiments, for example, as illustrated in FIG. 1, damping member 24 may comprise a plurality of damping member portions 14. Damping member 24 may comprise a slot and/or slots, such as spoke receiving surfaces 26, substantially corresponding to the dimensions of spokes 8, and is configured to enclose multiple faces and/or edges of spokes 8. In other embodiments, damping member 24 may be formed on or bonded to spokes 8. In still other embodiments, damping member 24 may be formed on or bonded to recesses 12, for example, via spoke recess interfaces 28, and/or injected around spokes 8 and in recesses 12. In yet other embodiments, some of damping member portions 14 may be formed on or bonded to spokes 8, may be formed on or bonded to recesses 12 and/or injected around spokes 8 and in recesses 12, and/or may be formed in any combination of the above, while other damping member portions 14 may be formed in different manners.

In further exemplary embodiments, inertia mass 10 and/or spokes 8 may include various features for retaining damping member 24 and/or damping member portions 14 within recesses 12 and for providing increased uniformity of stress throughout damping member 14. For example, recesses 12 may carry a lip around the opening thereof to better retain damping member portions 14. Similarly, spokes 8 may carry an outward flare or lip along the outwardly facing edge to facilitate driving of elastomeric member portions 14 into recesses 12.

According to various other embodiments, damping member 24 and/or damping member portions 14 may be configured to comprise a substantially uniform thickness or may be tapered, for example, to provide for easier assembly into recesses 12 of inertia mass 10. An exemplary damping member 24 may comprise different elastomers and/or different proportions to tune damper 2 according to various desired damping modes at various desired frequencies. In still other embodiments, elastomeric member portions 14 may be integrally formed as a single elastomer, for example, an exemplary damping member 24, as illustrated in FIG. 6.

In accordance with other exemplary embodiments, damping member 24 may be assembled first to spokes 8 or first within recesses 12. In other embodiments, some damping member portions 14 may be assembled first to spokes 8, and other damping member portions may be assembled first within recesses 12. In still other embodiments, damping member 24 may be disposed within vibration damper 2 after hub 4 is disposed within inertia mass 10.

According to further exemplary embodiments, damping member 24 may be molded, formed, or bonded on spokes 8 or within recesses 12. Damping member 24 may comprise any number of different segments, layers, reinforcing structures or elastomers. In other embodiments, damping member 24 may comprise any material suitable to provide the appropriate spring dampening, to withstand certain compressive forces, and/or to provide damping according to a number of desired damping modes at various damping frequencies. For example, damping member 24 may comprise ethylene propylene diene monomer rubber (EPDM), Nitrile, styrene-butadiene rubber (SBR), polybutadiene rubber (PBD), natural rubber, any other suitable elastomeric material and/or blends or combinations thereof.

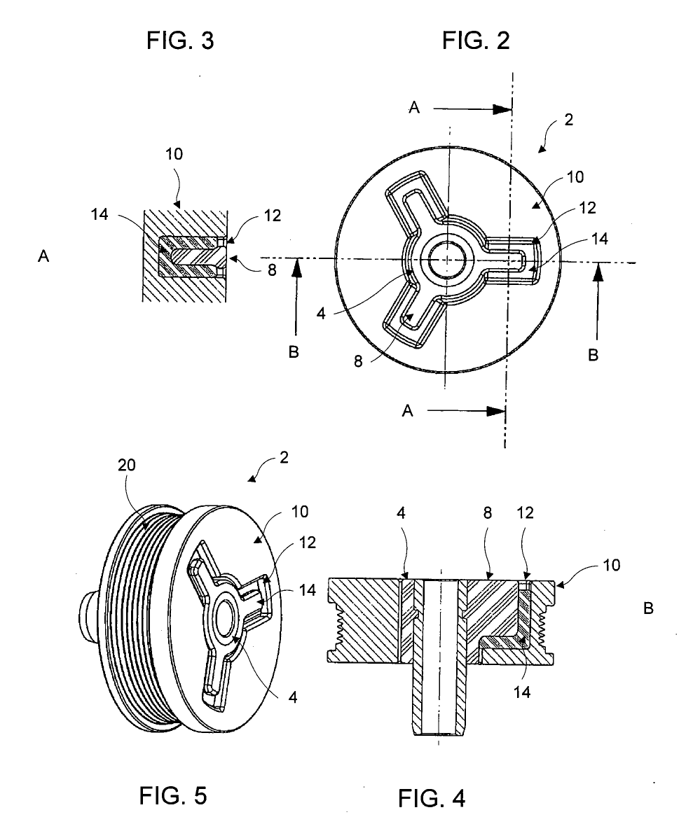

With reference now to FIG. 2, a front view of an exemplary embodiment of damper 2 shows hub 4 installed in inertia mass 10 with damping member portions 14 compressed between spokes 8 and the sidewalls of recesses 12.

With reference now to FIG. 3, a cross-sectional view of an exemplary embodiment of damper 2 shows damping member portions 14 compressed in recess 12 of inertia mass 10 around spoke 8. Damping member portions 14 may be compressed by insertion of the spoke-damping member portion assembly into recesses 12 of inertia mass 10. In certain embodiments, damping member portions 14 may be sized to be slightly shorter or narrower than spokes 8 before assembly and may then be extruded to substantially contact the remaining portions of spokes 8 and recesses 12. Accordingly, damping member 24 may be suitably configured and sized to be substantially uniformly compressed between inertia mass 10 and hub 4. In such an exemplary configuration, damping member 24 is subjected to substantially compressive stress during operation of vibration damper 2.

With reference now to FIG. 4, a longitudinal cross-sectional view of an exemplary embodiment of damper 2 illustrates damping member portion 14 compressed in recess 12 of inertia mass 10 around spoke 8 of hub 4. An exemplary damping member portion 14 may be configured to encompass the radially distal end and axially inward edge of spoke 8.

With reference now to FIG. 5, a perspective view of an exemplary embodiment of damper 2 shows pulley drive track 20 formed on the outer circumferential face of damper 2. Damper 2, according to various embodiments, is configured to comprise a small, unfilled gap between the outwardly-facing edge of spokes 8 and the perimeter of recesses 12. It is understood, however, that an exemplary damping member portion 14 may be extruded to fill this gap. According to other embodiments, damping member portions 14 may be disposed between any other suitable portions of hub 4 and inertia mass 10. For example, with momentary reference to FIG. 6, damping member 24 is configured to be disposed circumferentially around hub 4. In accordance with the various exemplary embodiments as described herein, and with other embodiments of the invention, vibration damper 2 may be configured to reduce parasitic vibration, reduced parasitic inertia, and increase vibration damping capabilities, among other advantages. In other embodiments of the invention, vibration damper 2 may be configured to increase vibration damping capabilities without reducing parasitic vibration and/or parasitic inertia.

In accordance with further exemplary embodiments, damper 2 is configured to provide a number of different damping modes. According to various exemplary embodiments of the present invention, damper 2 is configured to provide damping in any direction hub 4 is capable of moving with respect to inertia mass 10.

An exemplary damper 2 may comprise a number of damping axes, for example, (i) an axial axis that runs down the rotational axis of damper 2 (i.e., through the center of shaft receiving portion 30), (ii) a first radial axis that may be normal to and/or intersect with the axial axis, and/or (iii) a second radial axis that may be normal to and/or intersect with the axial axis and/or the first radial axis. In an exemplary embodiment, the axial axis, the first radial axis, and the second radial axis define a Cartesian space wherein damper 2 is located. In other embodiments, the first and second radial axes may not be normal to the axial axis, such that the three axis do not define a normal Cartesian space. In still other embodiments of the invention, damper 2 may comprise any number of axis about which and/or along which damping modes may occur.

In accordance with the various axes that damper 2 may comprise, damper 2 may be configured to provide damping related to various damping modes and various damping frequencies. For example, damper 2 may comprise (i) an axial damping mode along the axial axis; (ii) a first radial damping mode along the first radial axis; (iii) a second radial damping mode along the second radial axis; (iv) a torsional damping mode about the axial axis; (v) a first rocking, damping mode about the first radial axis; (vi) a second rocking, damping mode about the second radial axis; and (vii) a combination damping mode comprising at least one of (i), (ii), (iii), (iv), (v), and (vi) as defined above.

For certain other embodiments, experimental data is now described for various damping modes of various exemplary embodiments of the present invention. An exemplary damper 2 may exhibit a rocking mode frequency of approximately 61 Hz, which is significantly lower than a corresponding torsional mode frequency of approximately 114 Hz. An exemplary damper may also exhibit a bending/radial mode frequency of approximately 149 Hz and an axial mode frequency of approximately 102 Hz. In other embodiments of the invention, the axial mode may be configured to be above the torsional mode. Conventional dampers typically have the torsional mode being the first mode, however, certain engine configurations produce a rocking mode below the torsional mode. Thus, to match certain engine responses, it is desirable to have a vibration damper that likewise exhibits a rocking mode below the torsional mode (i.e., where the rocking mode is at a lower frequency, e.g., 61 Hz, than the frequency of the torsional mode, e.g., 114 Hz).

For still other embodiments, experimental data is now described for various damping modes of various exemplary embodiments of the present invention. An exemplary damper 2 may exhibit a rocking mode frequency of approximately 176-178 Hz, which is significantly lower than a corresponding torsional mode frequency of approximately 360-361 Hz. An exemplary damper may also exhibit a radial damping mode frequency of approximately 764-771 Hz and an axial mode frequency of approximately 255-256 Hz. It should be noted that the frequencies and frequency ranges noted above are only approximates related to exemplary scenarios and are not intended to limit the scope of the present invention. Various configurations of damper 2, various environmental conditions, various application-specific conditions, and other factors defining a particular use of damper 2 may impact the particular damping frequencies involved. Furthermore, various exemplary vibration dampers may exhibit different damping frequencies in the same damping mode at different times during operation. Thus, the frequencies are noted as “approximate” frequencies. Such language in the claims should be interpreted in a like manner.

Finally, while the present invention has been described above with reference to various exemplary embodiments, many changes, combinations and modifications may be made to the exemplary embodiments without departing from the scope of the present invention. For example, the inertia mass, hub and damping member may be configured in any manner suitable to provide for compression of the elastomer between the hub spokes and the inertia mass in a manner that allows for vibration to be damped via compressive stress. These other embodiments may be suitably selected depending upon the particular application or in consideration of any number of factors associated with the operation of the device. In addition, the techniques described herein may be extended or modified for use with other types of devices. These and other changes or modifications are intended to be included within the scope of the present invention.

1. A multiple-mode vibration damper, comprising:
an axial axis;
a first radial axis normal to the axial axis;
a torsional damping mode about the axial axis; and
a first rocking, damping mode about the first radial axis, wherein the first rocking, damping mode is below the torsional damping mode.

2. A multiple-mode vibration damper according to claim 1, wherein the torsional damping mode comprises a frequency between approximately 114 Hz and 361 Hz.

3. A multiple-mode vibration damper according to claim 2, wherein the first rocking, damping mode comprises a frequency between approximately 61 Hz and 178 Hz.

4. A multiple-mode vibration damper according to claim 1, further comprising:
a second radial axis normal to the axial axis;
an axial damping mode along the axial axis;
a first radial damping mode along the first radial axis;
a second radial damping mode along the second radial axis;
a second rocking, damping mode about the second radial axis; and
a combination damping mode comprising at least one of (i) the axial damping mode, (ii) the first radial damping mode, (iii) the second radial damping mode, (iv) the torsional damping mode, (v) the first rocking, damping mode, and (vi) the second rocking, damping mode.

5. A multiple-mode vibration damper according to claim 4, wherein the axial damping mode comprises a frequency between approximately 102 Hz and 256 Hz.

6. A multiple-mode vibration damper according to claim 4, wherein the first radial damping mode and the second radial damping mode comprise a frequency between approximately 149 Hz and 765 Hz.

7. A multiple-mode vibration damper according to claim 4, wherein the second rocking, damping mode comprises a frequency between approximately 61 Hz and 178 Hz.

8. A multiple-mode vibration damper according to claim 4, wherein the combination damping mode comprises a frequency between approximately 61 Hz and 765 Hz.

9. A vibration damper, comprising:
an inertia mass comprising a plurality of spoke recesses disposed within the inertia mass;
a damping member disposed within the plurality of spoke recesses, the damping member comprising:
a plurality of spoke receiving surfaces; and
a plurality of spoke recess interfaces;
a damper hub disposed within the damping member, the damper hub comprising:
a plurality of spokes extending radially from the damper hub, the spokes being disposed within the damping member proximate the spoke receiving surfaces; and
a shaft receiving portion disposed within the damper hub.

10. A vibration damper according to claim 9, wherein the damping member comprises an elastomeric spring damping member.

11. A vibration damper according to claim 9, wherein the plurality of spokes comprises three spokes.

12. A vibration damper according to claim 9, wherein the plurality of spokes comprises four spokes.

13. A vibration damper according to claim 9, wherein the damping member comprises a plurality of damping member portions individually disposable about the plurality of spokes.

14. A vibration damper according to claim 9, wherein the damping member comprises a plurality of damping member portions individually disposable within the plurality of spoke recesses.

15. A vibration damper according to claim 9, wherein the plurality of recesses comprise a plurality of damping member retaining lips.

16. A vibration damper according to claim 9, wherein the plurality of spokes comprise damping member securing lips.

17. A vibration damper according to claim 9, wherein the damping member is configured to damp vibrations through compression stress in the damping member.

18. A torsional vibration damper, comprising:
a hub;
a plurality of spokes projecting radially from the hub;
at least one compression-stressed damping elastomer positioned proximate the plurality of spokes;
an inertia mass, comprising a plurality of spoke recesses for receiving the plurality of spokes and the at least one compression-stressed spring damping elastomer;
a first damping frequency; and
a second damping frequency.

19. A torsional vibration damper according to claim 18, wherein the first damping frequency comprises a frequency between approximately 114 Hz and 361 Hz, and wherein the second damping frequency comprises a frequency between approximately 61 Hz and 178 Hz.

20. A torsional vibration damper according to claim 18, wherein the first damping frequency relates to a torsional damping mode, wherein the second damping frequency relates to a rocking, damping mode, and wherein the rocking, damping mode is below the torsional damping mode.

21. A torsional vibration damper according to claim 18, wherein the plurality of spokes comprises three spokes, and wherein the at least one compression-stressed spring damping elastomer comprises three compression-stressed spring damping elastomers.

22. A torsional vibration damper according to claim 18, wherein the plurality of spokes comprises four spokes, and wherein the at least one compression-stressed spring damping elastomer comprises four compression-stressed spring damping elastomers.

23. A torsional vibration damper according to claim 18, wherein the at least one compression-stressed spring damping elastomer comprises a single, circumferentially-encompassing, compression-stressed spring damping elastomer.

24. A torsional vibration damper according to claim 18, wherein the compression-stressed spring damping elastomer damps vibrations to which the torsional vibration damper is subject via compressive stress in the compression-stressed spring damping elastomer.
